(19) United States
(12) Patent Application Publication
(10) Pub. No.: US 2014/0373595 A1
(43) Pub. Date: Dec. 25, 2014

(54) METHOD AND INERTIAL SENSOR UNIT FOR SELF-CALIBRATION OF A YAW RATE SENSOR

(71) Applicants: Manuel GLUECK, St. Johann (DE); Alexander BUHMANN, Reutlingen (DE)

(72) Inventors: Manuel GLUECK, St. Johann (DE); Alexander BUHMANN, Reutlingen (DE)

(73) Assignee: ROBERT BOSCH GMBH, Stuttgart (DE)

(21) Appl. No.: 14/313,657

(22) Filed: Jun. 24, 2014

(30) Foreign Application Priority Data
Jun. 25, 2013 (DE) 10 2013 212 108.3

(51) Int. Cl. G01C 25/00

(52) U.S. Cl. CPC G01C 25/00
USPC 73/1.38

(57) ABSTRACT

A method is provided for self-calibration of a yaw rate sensor of an inertial sensor unit, in particular of a micromechanical yaw rate sensor of a micromechanical inertial sensor unit, the inertial sensor unit including an acceleration sensor and the yaw rate sensor, the yaw rate sensor including a calibration arrangement and an evaluation arrangement, a yaw rate signal of the yaw rate sensor being supplied to the evaluation arrangement in a first method step, an output signal being generated as a function of the yaw rate signal, the output signal being supplied to the calibration arrangement, an acceleration signal of the acceleration sensor being supplied to the calibration arrangement of the yaw rate sensor in a second method step, a correction signal being generated by the calibration arrangement as a function of the acceleration signal and of the output signal in a third method step, the output signal being calibrated as a function of the correction signal.

### CROSS-REFERENCE TO RELATED APPLICATIONS

The present application claims priority to and the benefit of German patent application no. 10 2013 212 108.3, which was filed in Germany on Jun. 25, 2013, the disclosure of which is incorporated herein by reference.

### FIELD OF THE INVENTION

The present invention is directed to a method for self-calibration of a yaw rate sensor.

### BACKGROUND INFORMATION

Micromechanical inertial sensors are known in general and are widely used as acceleration sensors or yaw rate sensors, for example. To compensate for inaccuracies in technical parameters, such micromechanical components are usually trimmed or calibrated to a setpoint value at the end of the manufacturing process. For example, a yaw rate sensor is acted upon by a reference yaw rate about a sensitivity axis for this purpose. Time drift due to aging or external influences, for example, temperature influences, are compensated for inadequately or not at all by such a calibration at the end of the manufacturing process. Expanded possibilities for use of yaw rate sensors and increasing demands on the long-term stability of such micromechanical sensors result in high development costs and comparatively long production times.

In addition, methods for calibrating yaw rate sensors are known, a static motion state of the yaw rate sensor being detected and the offset being determinable by averaging the sensor output as a function of the static motion state. In addition, there are known methods for calibrating yaw rate sensors, in which the position information from redundant position sensors is used for the calibration. Depending on the sensor configuration, systems with six or nine degrees of freedom may be used. The offset calculated on the basis of position differences is eliminated from the sensor signal in an external signal processing unit. In the field, redundant position sensors are usually uncalibrated. However, systematic errors in the output signals either cannot be reduced at all or may be reduced only with comparatively low accuracy.

### SUMMARY

An object of the present invention is therefore to provide a method and an inertial sensor unit for self-calibration of a yaw rate sensor so that the calibration method is simplified and the long-term stability of the sensor signals is improved, in particular with regard to aging and temperature fluctuations, and systematic errors in the output signals are eliminated with comparatively high accuracy.

The method according to the present invention and the inertial sensor unit according to the present invention for self-calibration of a yaw rate sensor according to the independent claims have the advantage over the related art that long-term stability of the output signal is improved by the fact that constant self-calibration is made possible during operation of the inertial sensor unit. Due to the constant self-calibration, it is advantageously possible in particular to use yaw rate sensors having comparatively great non-idealities, i.e., deviations from parameters of the yaw rate sensor from a certain setpoint value without going beyond certain limits of a specification. In addition, non-idealities of the yaw rate sensor are eliminated in a particularly simple manner, so that non-idealities include, for example, scattering in the component dimensions or other component properties of the components of the sensor core and/or evaluation means. These include in particular the zero point offset or quadrature errors of the yaw rate sensor. In addition, it is advantageously possible to carry out the self-calibration directly in the yaw rate sensor, the inertial sensor unit supplying a calibrated output signal, which does not require any further post-processing—for example, by an additional signal processing unit. According to the present invention, the calibration means for correcting a zero point error in the offset of the output signal, which is also known as the zero rate offset, is configured for adjusting a demodulation phase and/or for correcting a systematic error in the sensitivity of the yaw rate sensor. By adjusting the demodulation phase, the quadrature component in the output signal in particular is eliminated. For offset correction, for the demodulation phase adjustment and/or for the sensitivity correction, an estimation algorithm is used by the calibration means. In particular the gravitation vector, i.e., the component of the acceleration vector formed due to a gravitational force, is used for the self-calibration. It is advantageously possible in particular to omit a mechanical stimulus of the inertial sensor unit—for example, applying a reference yaw rate—at the end of the manufacturing process for calibration purposes.

Advantageous embodiments and refinements of the present invention may be derived from the subclaims as well as the description with reference to the drawings.

According to one preferred refinement, the yaw rate sensor has a motion detection means, in the second method step the acceleration signal being supplied by the acceleration sensor to the motion detection means, a motion signal being supplied to the calibration means by the motion detection means as a function of the acceleration signal, the correction signal being generated by the calibration means as a function of the motion signal, in particular the motion signal including a piece of motion information about a motion state of the inertial sensor unit and in particular in the case of an idle state of the inertial sensor unit, the motion information being supplied to the calibration means. In this way it is possible according to the present invention to carry out a constant self-calibration, i.e., a self-calibration during operation and/or after the end of the manufacturing process with comparatively high accuracy to eliminate the component-dependent deviations in component properties or non-idealities in particular.

According to one preferred refinement, in a first method step the output signal is generated from an evaluation signal of the evaluation means, the output signal being calibrated as a function of the correction signal and the evaluation signal in the third method step, the output signal being calibrated in particular by an offset correction of the evaluation signal by a summing unit as a function of the correction signal. According to the present invention, it is possible in this way to carry out an offset correction by the estimation algorithm directly in the yaw rate sensor by a particularly simple and inexpensive implementation. The simplicity of this implementation is achieved here, for example, by the fact that there is no direct coupling between the calibration means and the evaluation means, since the output signals of the calibration means, i.e., the correction signal, and the evaluation means, i.e., the evaluation signal, are added up by the summing unit to yield the output signal. The output signal here no longer has the offset of the evaluation signal in particular due to this summation.

According to one preferred refinement, the correction signal is supplied by the calibration means to the evaluation means in the third method step, the output signal being calibrated as a function of the correction signal by the evaluation means, the correction signal in particular having a piece of correction information, the correction information being generated in particular with the aid of data fusion of a piece of acceleration information from the acceleration signal and a piece of yaw rate information from the output signal. It is advantageously possible in this way to eliminate the non-idealities of the inertial sensor unit with the aid of data fusion and to determine correction values for the sensitivity and/or offset directly from the acceleration signal and/or test signal and/or yaw rate signal. For example, the acceleration signal here is generated in particular by an acceleration detection means formed from a function layer of the micromechanical acceleration sensor, and the yaw rate signal is generated from the yaw rate detection means formed in particular from another function layer of the micromechanical rotation rate sensor. The correction parameters of the, in particular triaxial, yaw rate sensor are determined here in particular by direct fusion of the acceleration information with the yaw rate information in the calibration means of the yaw rate sensor. This means, for example, that the acceleration information is related to an idle position of the inertial sensor unit or the yaw rate sensor, the offset of the yaw rate sensor being determined as a function of the acceleration information or the idle position information with high accuracy. In another method step, in particular one carried out at an earlier point in time, the offset of the yaw rate sensor is determined as a function of position differences, i.e., different positions and/or alignments, for example, in particular with a lower accuracy, by adjusting the demodulation phase. It is thus advantageously possible to adjust the offset parameters of the yaw rate sensor internally, i.e., directly in the yaw rate sensor, to correct the non-idealities of the yaw rate sensor in particular.

According to one preferred refinement, in the second method step the yaw rate detection means receives a test input signal, a test output signal, in particular the yaw rate signal, being generated as a function of the test input signal. It is thus possible according to the present invention to determine the sensitivity of the yaw rate sensor based on the electrical test output signal. This achieves the advantage over the related art that the sensitivity and/or offset parameters may be determined even when only one acceleration signal is available. Through the method according to the present invention, an improved and simplified method is thus made available, whereby the systematic errors in the output signals of the inertial sensor unit are eliminated with comparatively high accuracy. In particular a calibrated or uncalibrated acceleration signal may be used here for detection of the idle position, the self-calibration being carried out, for example, as a function of the idle position—hereinafter also referred to as the detected idle position-based calibration. In particular the calibration is not carried out here on the basis of position differences to achieve high accuracy.

In another method step, in particular one carried out at an earlier point in time, the offset is determined with the aid of the calibration means in particular with a greater error tolerance by fusing the acceleration information with the yaw rate information during a motion of the inertial sensor unit as a function of position differences, i.e., for example, as a function of different positions and/or alignments of the inertial sensor unit.

According to one preferred refinement, in the third method step a piece of initial sensitivity information of the yaw rate sensor is ascertained by the calibration means, in particular using a first estimation algorithm for noise minimization, as a function of the test output signal, the correction signal then being calibrated by the calibration means as a function of the piece of initial sensitivity information, the output signal then in particular being calibrated by correction of an offset of the output signal, of a demodulation phase error of the output signal and/or of a sensitivity error of the output signal as a function of the correction signal. It is advantageously possible in this way to eliminate the systematic error of offset and/or sensitivity of the yaw rate sensor with comparatively high accuracy as a function of the test input signal and the idle position ascertained by detection of the vector of the earth's acceleration. This achieves the advantage over the related art that there is no divergence even with great scattering in the sensitivity and/or offset parameters. In addition, it is advantageously possible according to the present invention to eliminate a component-related systematic error with high accuracy in ascertaining the sensitivity, for example, at the end of the manufacturing process.

According to one preferred refinement of the inertial sensor unit according to the present invention, the calibration unit is designed as an integrated circuit of the yaw rate sensor. It is advantageously possible in this way to carry out this self-calibration directly in the yaw rate sensor. In particular the available space of the inertial sensor unit may be kept comparatively small, so that a comparatively small inertial sensor unit is available, which nevertheless has the capability for self-calibration during operation.

According to one preferred refinement of the inertial sensor unit according to the present invention, the calibration unit of the yaw rate sensor has a motion detection means, the inertial sensor unit being configured to supply the acceleration signal from the acceleration sensor to the motion detection means, the motion detection means being configured to supply a motion signal to the calibration means, the calibration means being configured to generate the correction signal as a function of the motion signal, the motion signal in particular having a piece of motion information about a motion state of the inertial sensor unit. According to the present invention, it is possible in this way to carry out a constant self-calibration, i.e., self-calibration during operation and/or after the end of the manufacturing process with comparatively high accuracy in order to eliminate in particular the component-dependent deviations in the component properties or the non-idealities.

In one preferred refinement of the inertial sensor unit according to the present invention, the inertial sensor unit is configured to carry out the method according to the present invention.

Exemplary embodiments of the present invention are illustrated in the drawings and explained in greater detail in the following description.

### BRIEF DESCRIPTION OF THE DRAWINGS

FIGS. 1 and 2 schematically show an exemplary method for adjusting an inertial sensor unit.

FIG. 3 schematically shows an inertial sensor unit according to one specific embodiment of the present invention.

FIGS. 4 and 5 schematically show various specific embodiments of a calibration unit of the inertial sensor unit according to the present invention.

### DETAILED DESCRIPTION

Identical parts in the various figures are always provided with identical reference numerals and are therefore generally mentioned or explained only once.

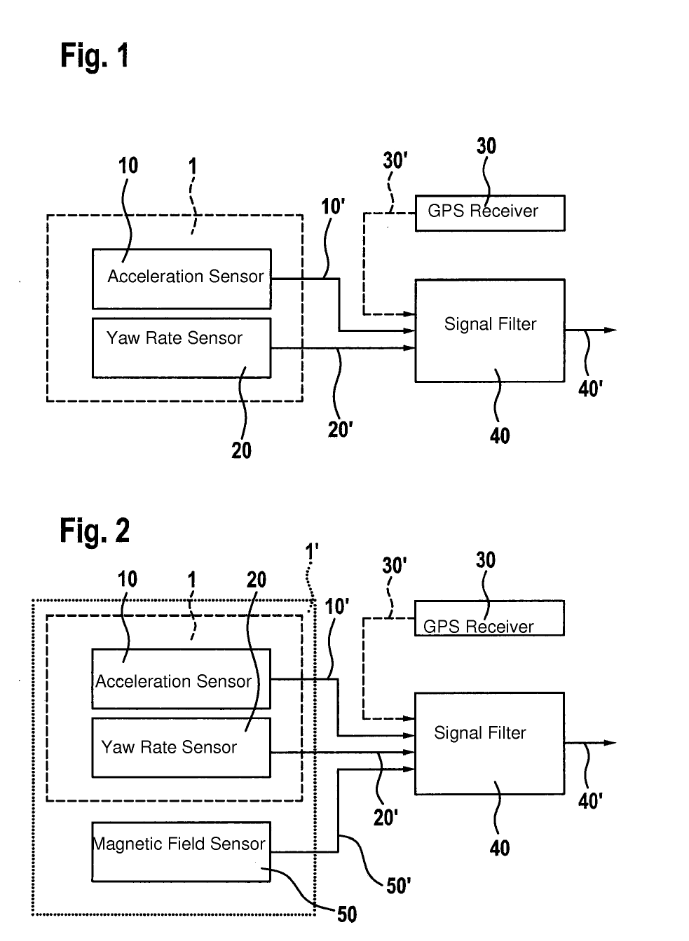

FIGS. 1 and 2 illustrate schematically exemplary methods for calibration of an inertial sensor unit 1. Sensor output signals 10′, 20′ are corrected during operation of inertial sensor unit 1 with the aid of data fusion of sensor output signals 10′, 20′ in a separate signal filter means 40 with the aid of an estimation algorithm, which is referred to here as loose coupling. For example, an acceleration signal 10′ of an acceleration sensor 10 is processed here by signal filter means 40 using yaw rate signal 20′ of a yaw rate sensor 20 to yield a filter output signal 40′. The inertial sensor unit includes acceleration sensor 10 and yaw rate sensor 20. However, sensor output signals 10′, 20′ are supplied to external signal filter means 40. Signal filter means 40 is in particular additionally connected to a receiver, for example, a global positioning system (GPS) receiver 30, a GPS signal 30′ being supplied to signal filter means 40 from GPS receiver 30 to increase the power. In the case of a triaxial yaw rate sensor 20 and a triaxial acceleration sensor 10, for example, an inertial sensor unit 1 having six degrees of freedom is provided. The specific embodiment illustrated in FIG. 2 corresponds essentially to the specific embodiment illustrated in FIG. 1, inertial sensor unit 1 being an integral part of a sensor unit 1′, sensor unit 1′ including a magnetic field sensor 50 in addition to inertial sensor unit 1, a magnetic field signal 50′ being supplied to signal filter means 40 by magnetic field sensor 50. In the case of a sensor unit 1′ including inertial sensor unit 1 according to the specific embodiment from FIG. 1 and a triaxial magnetic field sensor, for example, a sensor unit 1′ having nine degrees of freedom is provided. In the case of the specific embodiments illustrated in FIGS. 1 and 2, sensor output signals 10′, 20′ and in particular GPS signal 30′ and/or magnetic field signal 50′ are processed subsequently in a common estimation algorithm of signal filter means 40 to carry out a correction of the sensor output signals 10′, 20′, 50′. For example, a Kalman filter, in particular a nonlinear Kalman filter, in particular a sigma point Kalman filter, is used for the estimation algorithm.

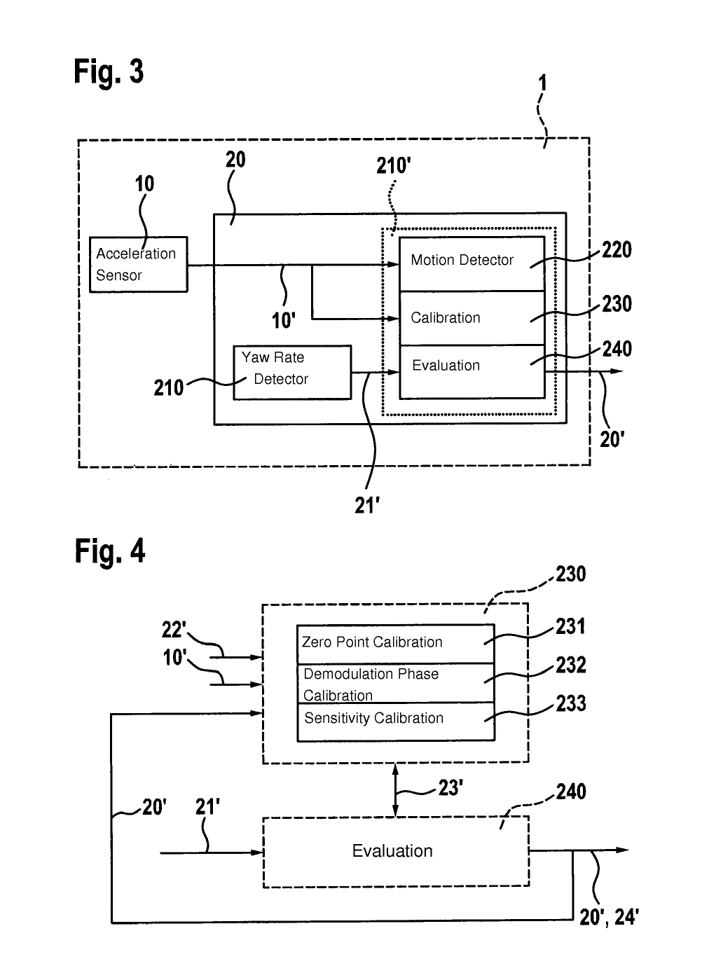

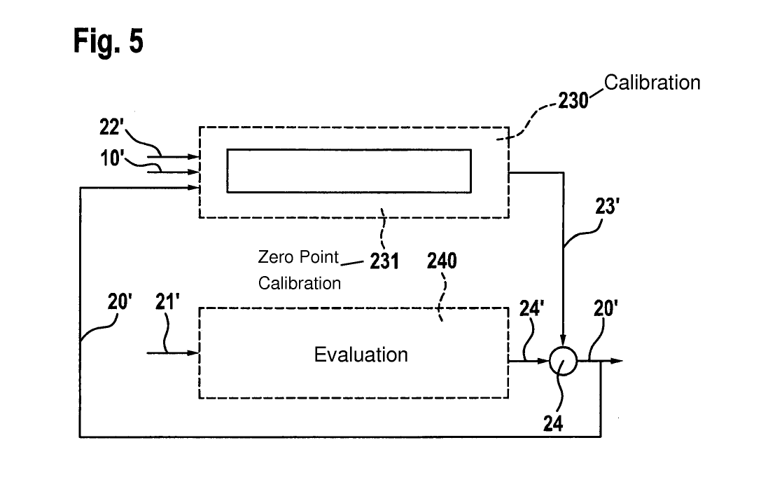

FIG. 3 schematically shows an inertial sensor unit 1 according to one specific embodiment of the present invention. Inertial sensor unit 1 has an acceleration sensor 10 and a yaw rate sensor. Inertial sensor unit 1 is preferably configured for calibrating yaw rate sensor 20 in particular during operation of inertial sensor unit 1. The yaw rate sensor has a yaw rate detection means 210 and a calibration unit 210′, calibration unit 210′ having a motion detection means 220, a calibration means 230 and/or an evaluation means 240. Calibration unit 210′ is designed in particular as an integrated circuit. An acceleration signal in particular having a piece of acceleration information is supplied by acceleration sensor 10 to motion detection means 220 and/or to calibration means 230. Acceleration signal 10′ is generated as a function of an acceleration force acting on acceleration sensor 10. In particular, acceleration sensor 10 has a sensitivity with respect to three directions of acceleration, in particular being mutually orthogonal (not shown). A yaw rate signal 21′ having a piece of yaw rate information in particular is supplied by yaw rate detection means 210 to evaluation means 240 of yaw rate sensor 20. Yaw rate detection means 210 in particular has a sensitivity with respect to three directions of rotation, in particular orthogonal, of yaw rate sensor 20. Evaluation means 240 is configured for generating an output signal 20′ as a function of yaw rate signal 21′. Calibration means 230 is configured in particular for generating a correction signal 23′ (see FIGS. 4 and 5) with the aid of data fusion of the acceleration information and the yaw rate information.

In addition, calibration unit 210′ here has motion detection means 220 and calibration means 230, calibration means 230 being configured to carry out an estimation algorithm for self-calibration. Motion detection means 220 here is configured for detecting a motion state of acceleration sensor 10, the motion state including in particular an idle state. Idle state here means that acceleration sensor 10 is in an equilibrium of forces. The motion detection means is configured in particular for supplying a piece of motion information to calibration means 230, the motion information being supplied in particular only to calibration means 230 for the case of a detected idle state of acceleration sensor 20. The motion information, which is also referred to here as a flag function, for example, is used as additional information for self-calibration of yaw rate sensor 20. A deviation in the effective parameters, for example, the offset and/or sensitivity of evaluation means 240 from a setpoint value is determined by calibration means 230. A piece of correction information is generated in particular by correction signal 23′, output signal 20′ being calibrated as a function of the correction information.

FIGS. 4 and 5 illustrate schematically various specific embodiments of an calibration unit 210′ of inertial sensor unit 1 according to the present invention. FIG. 4 shows essentially the inertial sensor unit according to the specific embodiment illustrated in FIG. 3, correction signal 23′, which is generated by calibration means 230 here, and correction information in particular, being supplied to evaluation means 240. Evaluation means 240 here is configured in such a way that output signal 20′ is generated and/or calibrated as a function of the correction information or of correction signal 23′. For example, output signal 20′ is generated with the aid of evaluation means 240 from yaw rate signal 21′ for the case when no correction signal 23′ is generated or supplied by calibration means 230 and/or the correction information does not indicate a correction of output signal 20′, and in this case output signal 20′ is also referred to as evaluation signal 24′. For example, output signal 20′ is corrected or calibrated in the case when the correction information indicates a calibration or a correction of output signal 20′ and/or for the case when correction signal 23′ is supplied. A correction or calibration of output signal 20′ here includes in particular a correction of the zero rate offset or a zero point calibration by a zero point calibration element 231 of calibration means 230, an adaptation of the demodulation phase in particular to eliminate a quadrature component in the rate channel with the aid of a demodulation phase calibration element 232 of the calibration means and/or a determination includes a calibration of the sensitivity of the yaw rate sensor with the aid of a sensitivity calibration element 233.

FIG. 5 illustrates an alternative specific embodiment of evaluation unit 210′, in which, in contrast with the specific embodiment illustrated in FIG. 4, the correction signal is not supplied to evaluation means 240. Evaluation means 240 here supplies an evaluation signal as a function of yaw rate signal 21′, the output signal being generated by adding up correction signal 23′ with evaluation signal 24′ with the aid of a summing unit 24. Calibration means 240 is configured for offset correction or for zero point calibration with the aid of a zero point calibration element 231. Calibration means 230 here generates correction signal 23′ as a function of motion signal 22′, acceleration signal 10′ and/or output signal 20′, correction signal 23′ in particular being configured in such a way that the calibrated output signal 20′—i.e., having little or no offset—is generated by adding up correction signal 23′ with evaluation signal 24′. This permits a particularly simple implementation of the self-calibration according to the present invention.

What is claimed is:

1. A method for self-calibration of a yaw rate sensor of an inertial sensor unit that includes an acceleration sensor and the yaw rate sensor, the yaw rate sensor including a calibration arrangement and an evaluation arrangement, the method comprising:
supplying a yaw rate signal of the yaw rate sensor to the evaluation arrangement;
generating an output signal as a function of the yaw rate signal;
supplying the output signal to the calibration arrangement;
supplying an acceleration signal of the acceleration sensor to the calibration arrangement;
generating a correction signal by the calibration arrangement as a function of the acceleration signal and of the output signal; and
calibrating the output signal as a function of the correction signal.

2. The method as recited in claim 1, wherein the yaw rate sensor is a micromechanical yaw rate sensor and the inertial sensor unit is a micromechanical inertial sensor unit.

3. The method as recited in claim 1, wherein:
the yaw rate sensor includes a motion detection arrangement,
the acceleration signal is supplied by the acceleration sensor to the motion detection arrangement,
a motion signal is supplied by the motion detection arrangement to the calibration arrangement as a function of the acceleration signal,
the correction signal is generated by the calibration arrangement as a function of the motion signal,
the motion signal includes a piece of motion information about a motion state of the inertial sensor unit, and
the motion information is supplied to the calibration arrangement in the case of an idle state of the inertial sensor unit.

4. The method as recited in 1, wherein:
the output signal is generated from an evaluation signal of the evaluation arrangement, and
the output signal is calibrated as a function of the correction signal and of the evaluation signal.

5. The method as recited in claim 4, wherein the output signal is calibrated by an offset correction of the evaluation signal with the aid of a summing unit as a function of the correction signal.

6. The method as recited in claim 1, wherein:
the correction signal is supplied by the calibration arrangement to the evaluation arrangement,
the output signal is calibrated by the evaluation arrangement as a function of the correction signal,
the correction signal includes a piece of correction information, and
the correction information is generated with the aid of a data fusion of a piece of acceleration information of the acceleration signal and a piece of yaw rate information of the output signal.

7. The method as recited in claim 1, wherein a yaw rate detection arrangement is acted upon by a test input signal, a test output signal being generated as a function of the test input signal.

8. The method as recited in claim 7, wherein the test input signal includes the yaw rate signal.

9. The method as recited in claim 7, wherein:
a piece of initial sensitivity information of the yaw rate sensor is ascertained by the calibration means,
the correction signal is generated by the calibration arrangement as a function of the piece of initial sensitivity information,
the output signal is calibrated with the aid of a correction of an offset of the output signal, at least one of a demodulation phase error of the output signal and of a sensitivity error of the output signal as a function of the correction signal.

10. The method as recited in claim 9, wherein the yaw rate sensor is ascertained by a first estimation algorithm for minimizing noise as a function of the test output signal.

11. An inertial sensor unit for self-calibration of a yaw rate sensor of the inertial sensor unit, comprising:
an acceleration sensor;
the yaw rate sensor including a yaw rate detection arrangement;
a calibration unit that includes a calibration arrangement; and
an evaluation arrangement, wherein:
the yaw rate sensor supplies a yaw rate signal of the yaw rate detection arrangement to the evaluation arrangement,
the calibration unit generates an output signal as a function of the yaw rate signal,
the calibration unit supplies the output signal to the calibration arrangement,
the inertial sensor unit supplies an acceleration signal of the acceleration sensor to the calibration arrangement of the yaw rate sensor,
the calibration arrangement generates a correction signal as a function of the acceleration signal and of the output signal, and
the calibration unit calibrates the output signal as a function of the correction signal.

12. The inertial sensor unit as recited in claim 11, wherein the yaw rate sensor is a micromechanical yaw rate sensor and the inertial sensor unit is a micromechanical inertial sensor unit.

13. The inertial sensor unit as recited in claim 11, wherein the calibration unit includes an integrated circuit of the yaw rate sensor.

14. The inertial sensor unit as recited in one of claim 11, wherein:
the calibration unit of the yaw rate sensor includes a motion detection arrangement,
the inertial sensor unit supplies the acceleration signal from the acceleration sensor to the motion detection arrangement,
the motion detection arrangement supplies a motion signal to the calibration arrangement, and
the calibration arrangement generates the correction signal as a function of the motion signal, the motion signal having a piece of motion information about a motion state of the inertial sensor unit.
